(19) United States
(12) Patent Application Publication
(10) Pub. No.: US 2014/0317596 A1
(43) Pub. Date: Oct. 23, 2014

(54) DEVICE-INDEPENDENT APPLICATION DEVELOPMENT BASED ON BUSINESS PROCESSES

(71) Applicants: George BOURIS, Athens (GR); Costis PAPADIMITRAKOPOULOS, London (GB)

(72) Inventors: George BOURIS, Athens (GR); Costis PAPADIMITRAKOPOULOS, London (GB)

(21) Appl. No.: 13/688,460

(22) Filed: Nov. 29, 2012

Related U.S. Application Data
(60) Provisional application No. 61/665,915, filed on Jun. 29, 2012.

(51) Int. Cl. G06F 9/44

(52) U.S. Cl. CPC G06F 8/20; G06F 8/30
USPC 717/106

(57) ABSTRACT

A platform for device-independent business application development, based on XML-based type instructions and associated parameters, is described. The platform supports the hierarchical mapping of business needs onto business processes, action steps and OS and device-independent application descriptions to be interpreted, build, and executed on client devices. Upon receipt of the application description by a client device, the latter being configured to read and interpret the XML-based instructions and parameters of the application description, it creates a local application. The operating system selection, user interface, driver, hardware and firmware specific functionalities and control are taken care of by the client device. In this way, an application developer need concern himself only with the mapping of the business needs and the XML-based instruction set and associated parameters rather than whether his code will be compatible with any actual client device hardware and software capabilities on which the application may ultimately be required to run.

### RELATED APPLICATIONS

This application claims the benefit of U.S. Provisional Application No. 61/665,915, filed on Jun. 29, 2012, commonly owned and assigned to the same assignee hereof.

### BACKGROUND

1. Field

The present exemplary embodiment relates to a platform for hierarchically mapping business needs onto business applications where the business applications are created as device-independent application descriptions based entirely on XML-based instructions and associated parameters.

2. Background

Enterprises are faced with a multitude of business needs and processes which need to be met and serviced efficiently, fast and cost effectively. They range from common processes, like contacting clients with e-mail, to more industry-specific processes according to their field of business. The ever increasing competition and need for ubiquitous access to information and communication has led to the widespread use of a number of information and communication technologies.

The introduction of mobile telephony and smart phones, in particular, has given a boost to this trend. An ever-increasing number of companies integrate mobile applications and web-services into their day-to-day operation for streamlining their operations and allowing improved access to vital data and improved client servicing, ultimately transferring and transmitting their office data over the air.

Current developments in mobile telephony and related systems have led to the availability of a wide variety of mobile devices and mobile operating systems. No clear winner or industry standard has emerged with four main operating systems and platforms competing for customers: iOS, Android, Blackberry, and Windows Mobile.

As a result, application developers need to develop versions of their software to support all available mobile operating systems and even make provisions for each of hundreds of devices' capabilities (e.g. screen size). In addition to that, developers also need to take into account legacy backend systems which need to be accessed to draw company data from.

As a further result, application development has proliferated into the development of several versions of the same application, necessitating specialized software development to support each version, and resulting in additional development time, complex modifications and updates, and higher software development and servicing costs.

Recent developments in this field have targeted the use of processes and programming languages that facilitate the streamlining of application development. Mark-up languages have been proposed as a solution to develop device-independent applications once and automatically create device-specific code that is distributed, installed and run on each mobile device. Examples include a user-interaction centric approach where the applications are described in terms of user interactions and graphical screens, user interaction states and layered representations.

Such applications may also use some web service description languages to access web services via an intermediate server.

Relevant art teaches the creation of applications descriptions with XML-based languages using some development environment. The developer can specify the target mobile device and use the development environment to compile OS and device-specific software code for distribution and installation to the target mobile device.

In other teachings, the XML description of the application is installed on the target device, where it is parsed and compiled to create an executable file.

The common parameter of these approaches is the description of the application as a set of user interactions and states.

This trend for simplifying application development using a device-independent approach is becoming widely employed among applications developers. This trend appears to grow stronger as in the near future, mobile device introduction and possibly mobile operating systems introduction are expected to intensify.

### SUMMARY

A platform for device-independent business application development based entirely on XML-based instructions and associated parameters is described.

The platform supports hierarchical mapping of business needs for the creation of client business applications. The hierarchy maps business needs onto business processes, and business processes onto action steps. Action steps are mapped onto Operating System and Device-agnostic application descriptions for distribution to target client devices together with relevant resources.

Upon receipt of the application description by a client device, the client device being configured to read and interpret the XML-based instructions and parameters of the application definition, the description is mapped by the device onto OS and device-specific software routines, which create a local business application.

The operating system selection, user interface, driver, hardware and firmware specific functionalities and control are taken care of by the client device. In this way, a business application developer need concern himself only with the mapping hierarchy and the XML-based instruction set and associated parameters rather than whether his code will be compatible with any actual client device hardware and software capabilities on which the application may ultimately be required to run.

### BRIEF DESCRIPTION OF THE DRAWINGS

FIG. 1 illustrates an exemplary system that can be used to support and service business processes.

FIG. 2 shows a process flow for mapping information from a client onto one or more business processes in accordance with an exemplary embodiment.

FIG. 3 is an architectural system level diagram including an editor to facilitate a developer mapping business processes and information described in the embodiment in FIG. 2.

FIG. 4 describes two types of XML packages created by the editor in FIG. 3 in accordance with an exemplary embodiment.

FIG. 5 is an example application description as referred to and described in the present application.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The acronym “XML” is intended to mean “eXtensible Markup Language”.

The acronym “GUI” is intended to mean “Graphical User Interface”.

The acronym “OS” is intended to mean “Operating System”.

A platform for hierarchically mapping business needs onto business applications is presented where the business applications are created as device-independent application descriptions based entirely on XML-based instructions and associated parameters.

The platform supports the creation of an application description to be executed on a client device. Upon receipt of the application description by a client device, the latter being configured to read and interpret the XML-based instructions and parameters of the application definition, the client device creates a local application.

The operating system selection, user interface, driver, hardware and firmware-specific functionalities and control are taken care of by the client device. In this way, an application developer need concern himself only with the hierarchical mapping of the business needs and the XML-based instruction set and associated parameters rather than whether his code will be compatible with any actual client device hardware and software capabilities on which the application may ultimately be required to run.

From the perspective of the application developer, the application definition may be designed without any advanced or complex code instruction set or protocol knowledge, is XML-based, and is designed without concern of client device-specific customization functionality or support in mind.

From the client device perspective, the client device need only be able to understand, support and execute XML-based instructions.

A hierarchical business-oriented approach is provided whereby business needs are mapped onto business processes, action steps, and device-independent application descriptions for distribution to target client devices. At the client devices, the application descriptions are received together with relevant resources, are parsed and interpreted, and are mapped onto OS and devices-specific software routines to build the client application.

In an exemplary embodiment, applications are described using an XML-based programming language and configured so as to be agnostic of the specific hardware and software capabilities of the client device on which the application description is to run. This allows programming a software application once in a way that can be used on any operating system or client device.

In one aspect, the application description (not any source code or executable) is transmitted to the client device and the client device interprets it using embedded software, builds the application and deals with the specific functionalities related to the operating system, user interface, device drivers, hardware and firmware.

In a further exemplary embodiment, a client-server system environment is contemplated, with a plurality of thin clients capable of being supported. The clients are agnostic to the underlying applications and can interpret data and commands received from the server. Clients communicate and present information in graphical page format, while the server is responsible for communication with 3rd party servers, other clients and legacy systems, and for operations on the data.

In other exemplary embodiment, a server is employed to synchronize data, client software, and XML definitions, and caching processes. The client device may be configured with appropriate embedded client software or firmware which is installed once on a client device, is specific to the underlying operating system, and is used to interpret, build and execute any application description written in the proposed programming language.

The present exemplary embodiment is directed to techniques for defining, building, and running device-independent applications in a client-server environment. The goal is to create business applications that service business needs, in a way that the applications can be written once in a descriptive language and executed in a variety of devices running one of a plurality of operating systems. The exemplary embodiment refers to the process of mapping business needs and describing such applications, to a suitable system for the application descriptions, the running of the applications, data access and manipulation and synchronization.

As noted above a number of approaches have been reported in literature for device-independent application development. The exemplary embodiment proposes a business-process-centered approach and the interpretation of the application description on the client device without the need for compiling and transmitting any source or executable application code to the client device.

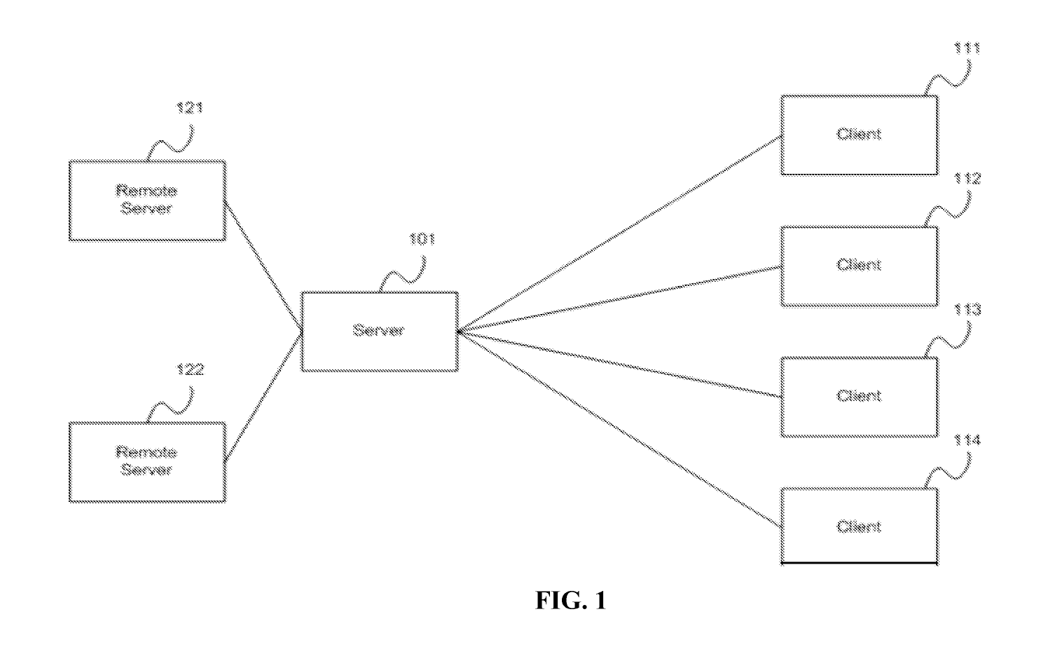

FIG. 1 illustrates an exemplary system that can be used to support and service business processes. A Server computing device 101 is connected to a plurality of Client Devices 111-114. The client devices 111-114 can be mobile devices, which are wirelessly connected to the Server 101 via any type of wireless network or combination of wired and wireless links. The Server 101 can also be connected to Remote Servers 121-122, such as 3rd party servers, which could include legacy systems. Server 101 connections to remote servers 121-122 could be implemented with any type of network and Web Services architectures could be used to standardize operation.

In one embodiment, a Client device 111 requests specific data items in a specific format from Server 101. Server 101 may check whether it has the requested data items and replies by sending the data items in the specified format.

If it does not have the requested data items or if their cached version is out of date, the Server 101 requests them from the Remote Server 122 which holds them. Upon reception of the data items, Server 101 performs any data manipulation that may be required and replies to the Client device 111, which requested the data items.

This simple framework of data request, fetching, manipulation, downloading to the Client Devices and displaying is an exemplary technique to map any business process into simple device-independent operations.

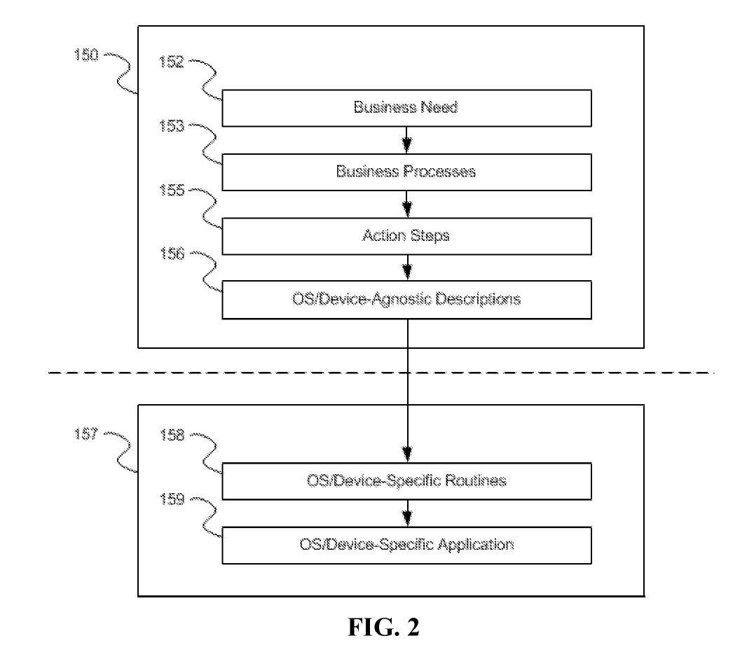

FIG. 2 shows a process flow for mapping information from a client onto one or more business processes in accordance with an exemplary embodiment.

Referring to the example in FIG. 2, the Business Need 152 of getting information from a client may be mapped onto one or more Business Processes 153 comprising, for instance, the exchange of standardized forms through e-mail messages. The exemplary embodiment maps business processes onto a number of simple action steps 155 like “send” or “receive” e-mail message.

At a lower level the action of receiving an e-mail message is then mapped onto OS and device-agnostic descriptions 156, which in this exemplary embodiment are described with an XML-based language.

Mapping steps 150 are performed at the server 101 during the development of the business application.

Following the creation of the application descriptions 156, the server 101 distributes them together with relevant resources to the target client devices 111-114. Following reception of the application descriptions at a client device 111, the device uses embedded software to parse and interpret the descriptions and invoke OS and device-specific software routines 158 and relevant resources to build the actual application 159 that will run on the client device 111.

Mapping steps 157 are all executed at the target client device.

In this exemplary embodiment, Operating System-specific and Client Device-specific routines 158 are used in the system illustrated in FIG. 1, where the Client device 111 wants to receive an e-mail message. This operation will be performed by Server 101, which will connect to the Remote Server 122, fetch it and forward it to Client Device 111. The Client Device 111 receives the requested data items, performs any necessary formatting and outputs them in a graphical page on its screen.

The business process 153 and the action steps 155 can be described with the proposed XML-based based language, where this description is installed at the client device and is interpreted and used to build and execute the final application by embedded software running on the client device.

The proposed embodiment is by no means limited to the functionality of this example, which serves only as an indication of how the mapping of Business Processes can be made onto device-independent applications.

The data items described above may be stored in one or a multitude of databases at the Server 101, and additional copies may be locally cached in a database on the Client Device 111.

In another embodiment, the role of the Client and Server devices in data transfer may be reversed. For instance, the Server 101 could push data items to the Client device 112 as in the case of an RSS feed. Again connection to a Remote Server (e.g. 121) and request handling between the Server 101 and the Client device 112 are performed. They are not described in detail as such handshaking mechanisms are described in various standards and are easily understood by a skilled reader in related art.

The description of functionalities and tasks, such as those mentioned above, are programmed using a novel programming language based on an eXtensible Mark-up Language (XML). This language forms a new process for developing device-independent software applications that can be written once and run on any supported operating system and device.

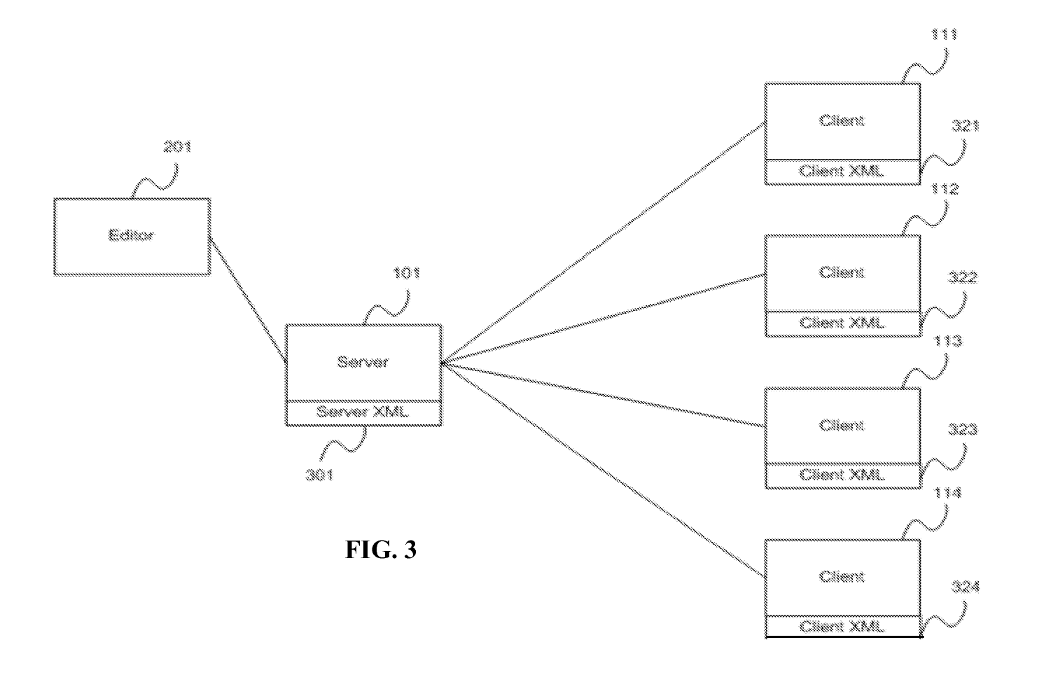

FIG. 3 is an architectural system level diagram including an editor to facilitate a developer mapping business processes and information described in the embodiment in FIG. 2.

Referring to FIG. 3, an Editor 201 is used to allow the developer to perform the mapping described in FIG. 2. Editor 201 also creates or modifies the XML instructions describing a business application. Application description distribution and installation is facilitated by creating software packages containing the XML-based description of the business application and a set of resources, where the resources are specific to the target device.

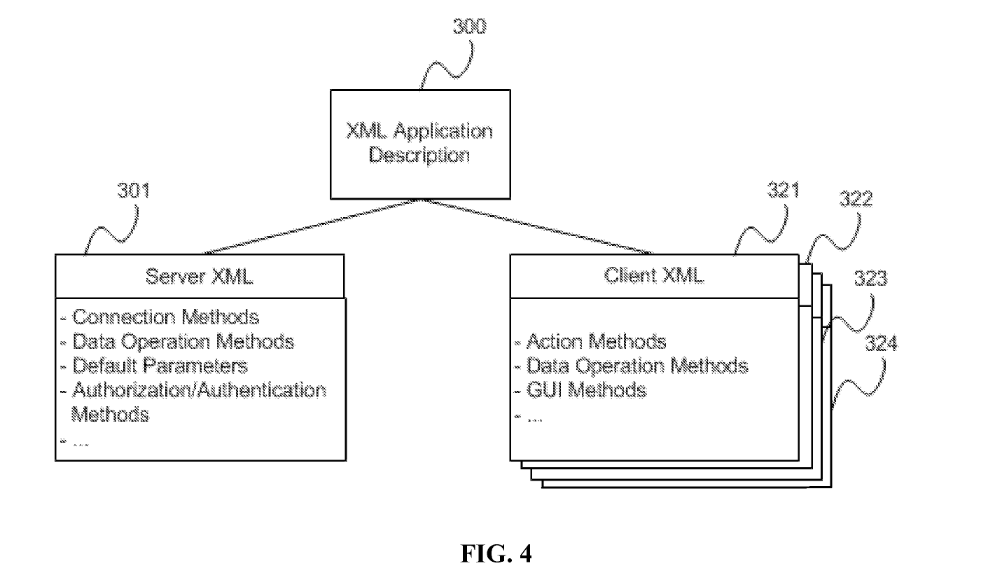

FIG. 4 describes two types of XML packages created by the editor in FIG. 3 in accordance with an exemplary embodiment.

A Server version (Server XML Package 301) for installation at the Server 101 and Client versions (Client XML Packages 321-324) for installation at the Client devices 111-114.

In one embodiment, the Editor 201 may be a computer program with a graphical environment.

The editor 201 is also used to build the business application from the application description and related resources, compile, debug, and emulate the application for the target client devices 111-114 prior to distribution of the application description to the client devices 111-114.

Every time an application is created, only the application descriptions 301 and 321-324, and related resources, are stored in the respective server and client devices. No executable files for the applications are installed on the client devices. As a result for every change, fix, or extension of the application, the developer only needs to edit the application description once and cover the server and all client devices. The server 101 and client devices 111-114 will interpret the application descriptions, and build the application based on software routines specific to their underlying operating systems and client specific hardware and software capabilities and other resources, such as multimedia data, like image, text, and sound. As a result, simpler, faster and cheaper application development can be achieved to service business needs and processes and run on any number and type of devices.

The application description 300 created by the developer is used to create the server XML package 301 and the client XML Packages 321-324 illustrated in FIG. 4. In this exemplary embodiment, the server package 301 includes “connection methods” for connection to Remote Servers 121-122, “data operation methods” for operations on data that will be downloaded to the mobile devices 111-114, “default parameters”, and “authentication and authorization methods” for client devices and their users. These operations may include, but are not limited to, data access, data updating, and data synchronization.

The client descriptions 321-324 include “action methods” describing any necessary actions that the client will take to prepare the data for presentation to the user, “data operation methods” describing operations done on the data, and “GUI methods” that describe in detail the look-n-feel of the graphical pages that are presented to the user. The application description is the same for all client devices. The resources used to build the application are dependent on the operating system and device characteristics.

In an alternate embodiment, synchronization is provided between the Server 101 and the Client devices 111-114. Synchronization may include, but is not limited to, synchronization of data, client software, and XML definitions, as well as techniques for caching.

The listing of the content of the application description for the server 301 and the client application descriptions 321-324 is not exhaustive and serves only as an example. This content list is extensible and can be populated with additional items that can be included into the proposed XML-based language definition.

The application definitions are interpreted at the Client devices 111-114 by a client embedded software program. The client program includes the definition of the XML-based device-independent application programming language. This program is specific to the operating system running on the mobile device, is independent of the applications and their descriptions, and is installed only once. It is not reinstalled at the client devices for any new applications. The client software needs updating only if a new definition of the XML-based language is created, a rare event compared to the frequency of introduction of new applications and the frequency of installing new versions of existing applications. The job of the client software is to parse the application descriptions, and to build and run the applications on the mobile device.

This approach further to simplifying the development of new applications allows the use of a Client device 111-114 that is agnostic of the application that is running. Instead the client understands simple operations, like data transmit and receive, simple data operations, and data presentation on the device screen. These operations are interpreted by the client software to take into account the underlying operating system, user interface, drivers, hardware, and firmware specific functionalities. All other complex operations like, but not limited to, data manipulation, communication with third party systems, legacy systems, and other mobile devices, data caching, user authentication and authorization, application description updating and version control are handled by the Server 101.

In another embodiment, the application description may include a script that allows the client to perform more complex operations and implement more complex timing of sequences of actions. As an example, scripts may be written in the Lua programming language, a scripting language with extensible semantics.

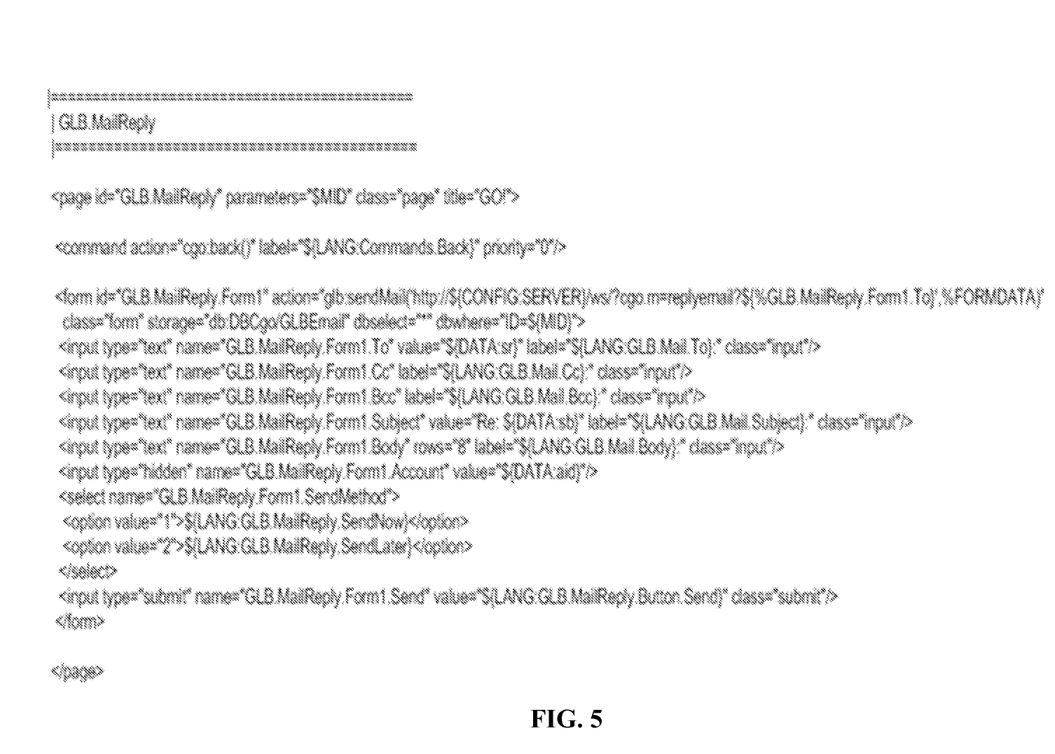

FIG. 5 is an example application description as referred to and described in the present application. More specifically, FIG. 5 is an example application description providing an application screen which allows a user to reply to an e-mail message. Various fields to be filled are pre-defined, such as “To”, “Bcc”, “Subject”, etc., actions like “SendNow” and “SendLater”, and buttons like “MailRepply”. The application description is interpreted by the client software and execution is controlled by user input at the mobile device. This same application description may be interpreted by any mobile device that is running embedded client software loaded with the same version of the XML-based language. The client software can build the application from the interpreted description using resources (e.g. images and text) installed in the mobile device or transmitted to it together with the application description.

The client device may run at least one application described with the above XML-based language. Updating an application or installing a new application to the client may be done by contacting the server. The server authenticates the user and checks which applications and functionalities are available to the user based on his profile and responds by sending the application description and any associated resources only for the new version or the new application. The server does not need to resend any previously installed applications that exist on the client.

The proposed XML-based solution offers an application development framework that overcomes several issues encountered in Web-based application development. Namely, it provides a secure solution where mobile device/data/user/application management is easier to be designed, implemented and enforced.

It does not require complex programming skills, and is independent of web browser implementations, therefore avoiding incompatibilities and potential problems. Furthermore, it requires no plug-ins. Only updates in the language definition need to be synchronized between the server and the client devices. Client embedded software is used to render the XML-based language and create the applications, which client software may also be updated by the server pushing new versions to clients or by other suitable updating mechanisms.

The proprietary nature of the development framework and XML-based language allows for better control of the updating mechanism. It also separates the business logic from the actual web-pages, and allows an extra level of security and control by using an intermediate server between the clients and the third party servers and web-services.

Future adoption of the HTML5 standard is envisaged for the rendering part of the web applications. It can be used as a front-end of the XML-based applications while the client-and server logic of the application is still created by the proposed development framework and language for the advantages it offers.”

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1-22. (canceled)

23. In a client device having client embedded software where the client embedded software is specific to the client device in terms of the client specific hardware and software capabilities of the client device, a method comprising:
receiving, from a remote location, a set of XML-based instructions associated with a business specific application to run on the client device; and
using the client embedded software, creating an application description from the received set of XML-based instructions that will run on the client device and which will be able to take advantage of the client specific hardware and software capabilities of the client device.

24. The method of claim 23, wherein the client embedded software is a software routine downloaded by the client device from a remote server.

25. The method of claim 24, further comprising sending information from the client device to the remote server identifying the client device so that the software routine returned by the remote server includes information about the client specific hardware and software capabilities of the client device.

26. The method of claim 25, wherein the received set of XML-based instructions are instructions that allow the client embedded software in a different client device to be able to create a different application description using client embedded software that is specific to that different client device and which is based on the client hardware and software capabilities associated with that different client device.

27. The method of claim 26, wherein the received set of XML-based instructions is business enterprise software configured to be downloaded from any client device owned by an enterprise, with updates and re-installs possible across the enterprise by making changes to the XML-based instructions sent or resent to such any client device.

28. The method of claim 23, wherein the received set of XML-based instructions are instructions that allow the client embedded software in a different client device to be able to create a different application description using client embedded software that is specific to that different client device and which is based on the client hardware and software capabilities associated with that different client device.

29. The method of claim 28, wherein the received set of XML-based instructions is business enterprise software configured to be downloaded from any client device owned by an enterprise, with updates and re-installs possible across the enterprise by making changes to the XML-based instructions sent or resent to such any client device.

30. A client device having client embedded software that is specific to the client device in terms of the client specific hardware and software capabilities of the client device, comprising:
means for receiving, from a remote location, a set of XML-based instructions associated with a business specific application to run on the client device; and
means for using the client embedded software, creating an application description from the received set of XML-based instructions that will run on the client device and which will be able to take advantage of the client specific hardware and software capabilities of the client device.

31. The client device of claim 30, wherein the client embedded software is a software routine downloaded by the client device from a remote server.

32. The client device of claim 31, further comprising means for sending information from the client device to the remote server that identifies the client device so that the software routine returned by the remote server includes information about the client specific hardware and software capabilities of the client device.

33. The client device of claim 32, wherein the received set of XML-based instructions are instructions that allow the client embedded software in a different client device to be able to create a different application description using client embedded software that is specific to that different client device and which is based on the client hardware and software capabilities associated with that different client device.

34. The client device of claim 33, wherein the received set of XML-based instructions is business enterprise software configured to be downloaded from any client device owned by an enterprise, with updates and re-installs possible across the enterprise by making changes to the XML-based instructions sent or resent to such any client device.

35. The client device of claim 30, wherein the received set of XML-based instructions are instructions that allow the client embedded software in a different client device to be able to create a different application description using client embedded software that is specific to that different client device and which is based on the client hardware and software capabilities associated with that different client device.

36. The client device of claim 31, wherein the received set of XML-based instructions is business enterprise software configured to be downloaded from any client device owned by an enterprise, with updates and re-installs possible across the enterprise by making changes to the XML-based instructions sent or resent to such any client device.

37. A non-transitory computer program product including embeddable software for use in a client device as client embedded software, which embedded software is specific to the client device in terms of the client specific hardware and software capabilities of the client device, the embeddable software including instructions to cause the client device to:
receive, from a remote location, a set of XML-based instructions associated with a business specific application to run on the client device; and
create an application description from the received set of XML-based instructions that will run on the client device and which will be able to take advantage of the client specific hardware and software capabilities of the client device.

38. The non-transitory computer program product of claim 37, wherein the client embedded software is stored on a remote server and configured to be downloaded by the client device from the remote server.

39. The non-transitory computer program product of claim 38, wherein the embedded software is configured to be retrieved by the client device in response to its sending information from the client device to the remote server that identifies the client device so that the client embedded software returned by the remote server includes information about the client specific hardware and software capabilities of the client device.

40. The non-transitory computer program product of claim 39, wherein the received set of XML-based instructions are instructions that allow the client embedded software in a different client device to be able to create a different application description using client embedded software that is specific to that different client device and which is based on the client hardware and software capabilities associated with that different client device.

41. The non-transitory computer program product of claim 40, wherein the received set of XML-based instructions is business enterprise software configured to be downloaded from any client device owned by an enterprise, with updates and re-installs possible across the enterprise by making changes to the XML-based instructions sent or resent to such any client device.

42. The non-transitory computer program product of claim 37, wherein the received set of XML-based instructions are instructions that allow the client embedded software in a different client device to be able to create a different application description using client embedded software that is specific to that different client device and which is based on the client hardware and software capabilities associated with that different client device.
